(19) United States
(12) Patent Application Publication
(10) Pub. No.: US 2008/0019144 A1
(43) Pub. Date: Jan. 24, 2008

(54) Backlight module

(75) Inventor: Ching-Lung Chang, Padeh City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD

(21) Appl. No.: 11/489,568

(22) Filed: Jul. 20, 2006

(51) Int. Cl. F21V 7/04

(52) U.S. Cl. 362/600

(57) ABSTRACT

A backlight module is provided, including a back-plate, a light-source structure having a cover, wherein the light-source structure set on the back-plate, and a resilient element, which can be set on any one of the cover of the light-source structure and the back-plate. The cover of the light-source structure is electrically contacts with the back-plate and furthermore fixed the cover on the back-plate via the resilient element. Therefore, the resilient element is utilized to force the metal surface of the cover of the light-source structure to tightly contact with the metal of the back-plate, and so as to enhance the grounding effect.

### BACKGROUND OF THE INVENTION

1. Field of the Invention

The present invention relates to a backlight module, and more especially, relates to a backlight module having good grounding effect.

2. Description of the Prior Art

Nowadays, the multi-media related products are progressing fast by taking advantage of the diversified technology progress of the semi-conductor component and the display apparatus. The issues of the space utilization and the power consumption limit the development of the known display apparatus, such as the Cathode Ray Tube (CRT). The trend of the current technology is light weight, thin thickness, and low power consumption. Therefore, the flat panel apparatus, such as the liquid crystal display (LCD), which meets the technology trend requirement and has high display quality, has acted as a primary role of the display market.

Because the LCD is a not a self-illuminated type of display, it needs a light-source to display the image. As a result, LCD always uses a backlight module to serve as its light-source, wherein the function of the backlight module is to provide the light-source with high luminance and uniform light distribution. In general, the backlight module consists of a light-source, a light cover, a reflector, a light guide plate, a diffusion sheet, a brightness enhancement film and a outer shell. The major types of the light-source for the current backlight module are the white light emitting diode (LED) and the cold cathode fluorescent lamp (CCFL), wherein the white LED applied for the apparatus with a small-size display, such as the cell phone, and the CCFL applied for the apparatus with the big-size display, such as the LCD TV.

Along with the increase of the demand of the large-size display, the requirement of strong luminance for the light-source is going up. However, the increase of the current density of the lamp tube, which is going to supply to the light-source, will bring the thermal energy and raise the opportunity of current leakage. Or otherwise, the gathering of charge density will be easy to induce the static electricity effect to damage the display panel. Therefore, one important point for assembling the light-source of the backlight module is the grounding manner. A screw or a conductive aluminum foil may complete the grounding of the backlight module according to the prior art. Please refer to FIG. 1, which illustrates the grounding apparatus structure for the backlight module according to a prior art. The grounding structure of the backlight module 100 includes a back-plate 200, a lamp set 300, a screw 400, and a conductive aluminum foil 402. Wherein the lamp set 300 consists a lamp 304 and a reflective cover 302 which cover the lamp 304, and the reflective cover 302 is screwed on the back-plate 200 by a screw 400 to force the reflective cover 302 tightly contact with the back-plate 200 to achieve the grounding purpose. Or alternatively, adhering a conductive aluminum foil 402 on the reflective cover 302 can also be used to achieve the grounding purpose. Or furthermore, these two methods can be adopted at the same time to gain a better grounding effect. However, the extra material cost for the screw 400 and the conductive aluminum foil 402 is necessary no matter which method is selected. And, the manpower cost and the risk of man-made carelessness will increase.

### SUMMARY OF THE INVENTION

According to the issues mentioned previously, the present invention provides a backlight module.

One object of this invention is to provide a backlight module, using a bend portion of the resilient element to make the backlight module keep the interference function after assembling to achieve the grounding purpose.

One object of this invention is to provide a backlight module, which a resilient element produced by the metal punched one-piece form is set on the back-plate or on the cover of the light-source structure. By utilizing the resilient element to electrically contact with the back-plate and the cover of the light-source structure, a discharge path is provided for the electric charge in a forced-interference manner.

One object of this invention is to provide a backlight module, which the electrically contact manger by using a resilient element is adopted to replace the fixing manner by a screw and the adhering manner by using a conductive aluminum foil. It can simplify the manufacturing process and raise the production yield and the productivity.

One object of this invention is to provide a backlight module, a good grounding effect is provided under the condition that no assembly complexity for the backlight module is increased.

Accordingly, one embodiment of the present invention provides a backlight module, which includes: a back-plate; a light-source structure, wherein the light-source structure includes a cover and a light-emitting component set inside the cover; and a resilient element set on the back-plate and tightly touched the cover. Wherein the cover electrically contacts with the back-plate by using the resilient element.

Accordingly, another embodiment of the present invention provides a backlight module, which includes a back-plate; a light-source structure set on the back-plate, wherein the light-source structure includes a cover and a light-emitting component set inside the cover; and a resilient element set on the cover of the light-source and tightly touch the back-plate, wherein the cover electrically contacts with the back-plate via the resilient element.

These and other objects will appear more fully from the specification below.

### BRIEF DESCRIPTION OF THE DRAWINGS

FIG. 1 is a schematic diagram to illustrate the grounding apparatus structure for the backlight module according to a prior art;

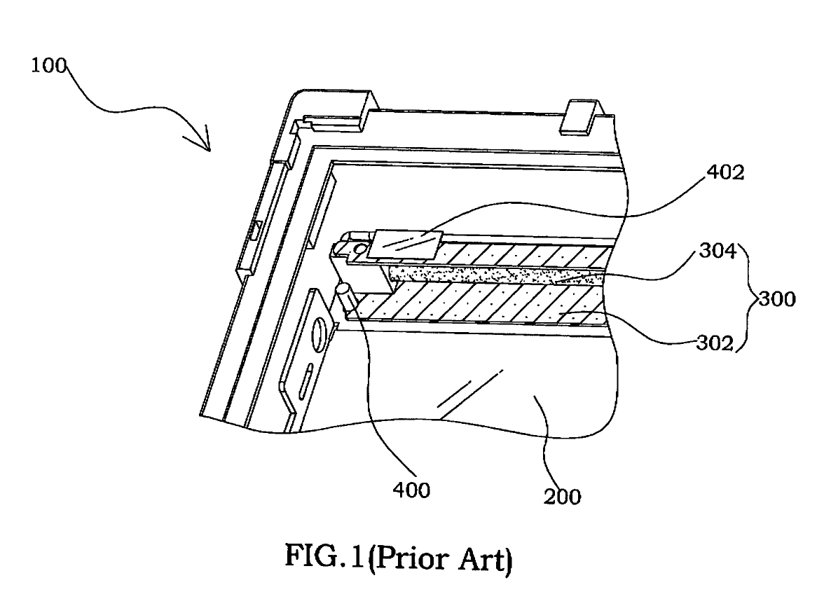

FIG. 2 is a schematic diagram to illustrate the backlight module in accordance with an embodiment of the present invention; and

FIG. 3 is a schematic diagram to illustrate the backlight module in accordance with another embodiment of the present invention.

### DETAILED DESCRIPTION OF THE INVENTION

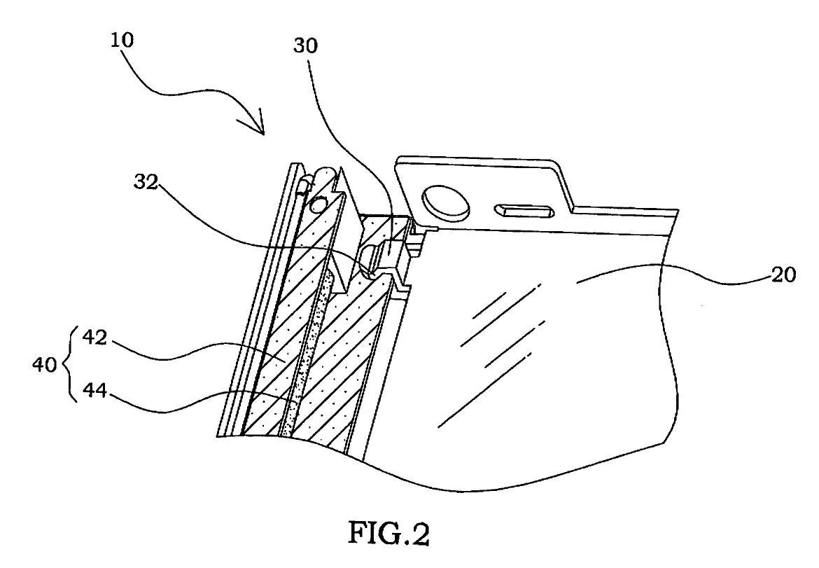

Please refer to FIG. 2, which illustrates the backlight module in accordance with an embodiment of the present invention. The backlight module 10 includes a back-plate 20, a resilient element 30 and a light-source structure 40. The light-source structure 40 is set on the back-plate 20, wherein the light-source structure 40 has a cover 42 and a light-emitting component 44 set inside the cover 42. The resilient element 30 is also set on the back-plate 20 and tightly touches the cover 42. Hence, the cover 42 electrically contacts with the back-plate 20 via the resilient element 30. In this embodiment, the resilient element 30 and the back-plate 20 are one-piece form, and the resilient element 30 has a bend portion 32, which is used to clip the cover 42 of the light-source structure 40 onto the back-plate 20, and the bend portion 32 also force the back-plate 20 tightly contact with the metal surface of the cover 42 so as to achieve the grounding purpose. In one embodiment, the light-emitting component 44, which can be one of the CCFL and the hot cathode fluorescent lamps (HCFL), wherein the light-emitting component 44 is used to provide the source-light to the backlight module 10. In case the light-emitting component 44 is one of the CCFL and the HCFL, the cover 42 of the light-source structure 40 can be a reflective cover with a reflective coating layer. In another embodiment, in case the light-emitting component 44 is composed of a plurality of LEDs, then the cover 42 of the light-source structure 40 without coating the refection layer can provide as a good light-source.

Accordingly, the backlight module 10 of this embodiment can be applied for the side-light backlight module and the direct-light backlight module. About the assembly method of the backlight module for this embodiment, the first step is clipping the light-source structure 40 and the back-plate 20 by sing the bend portion 32 of the resilient element 30, then assembling other components to form a complete backlight module. Thus, there is no difficult step for the assembly.

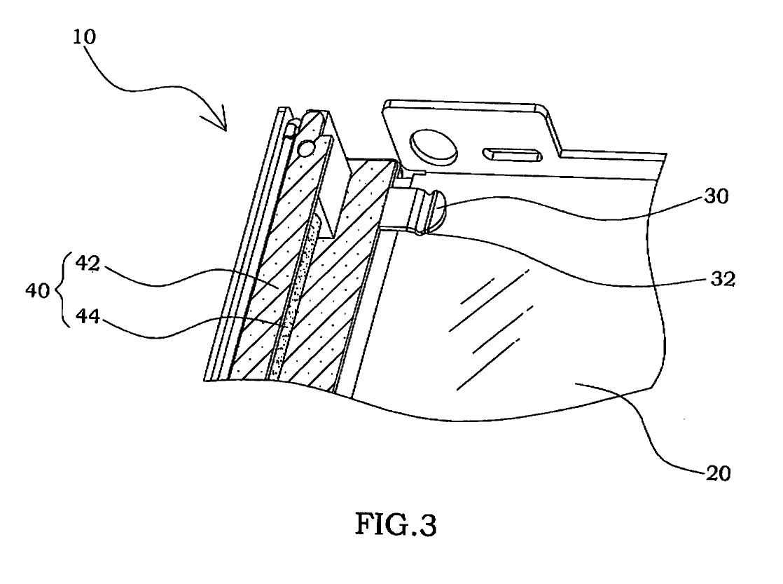

Please refer to FIG. 3, which illustrates the backlight module in accordance with another embodiment of the present invention. The light-source structure 40 having a cover 42, such as a reflective cover with reflection layer coating, and a light-emitting component 44 in the cover 42,wherein the light-source structure 40 is set on the back-plate 20. In this embodiment, the light-emitting component 44 can be selected from the group consisting of CCFL, HCFL, and a plurality of LEDs. In case the light-emitting component 44 is the LEDs, the cover 42 of the light-source structure 40 without coating a refection layer can provide as a good light-source. The difference between this embodiment and the last one is the location of the resilient element 30. The resilient element 30 is set on the cover 42 of the light-source structure 40 and tightly touches the back-plate 20, wherein the cover 42 electrically contacts with the back-plate 20 via the resilient element 30. In this embodiment, the resilient element 30 has a bend portion 32, which is used to tightly contact with the cover 42 and the back-plate 20. For example, a tight-fit manner is used to gain a good electrical contact. A discharge path for the electric charge caused from the leakage current of the light-source structure 40 is provided by tightly fitting the cover 42 and the back-plate 20. In one embodiment, the resilient element 30 and the cover are one-piece form. For example, the resilient element 30 is produced by using the method of metal punched one-piece form at the same time with the forming of the cover 42. In order to get a better grounding effect, the resilient element 30 can be set on a side, which the cover 42 contacts with the back-plate 20.

In this embodiment, the assembly method of the backlight module is the same as the last embodiment. The first step is clipping the light-source structure 40 and the back-plate 20 by using the bend portion 32 of the resilient element 30, and then assembling other components to form a complete backlight module. Thus, there is no difficult step for the assembly.

Accordingly, one characteristic of the present invention is to utilizing the bend portion of the resilient element to force the light-source structure electrically contacts with the back-plate to achieve the grounding purpose. Exploiting the tight-contact manner of the bend portion can guarantee the better electrical connection between the light-source structure and the back-plate. Besides, the bend portion of the resilient element can also fix the light-source structure on the back-plate, which can reduce the crack situation of the light-emitting element caused by the sway of the backlight module. And, the resilient element can be set on the back-plate or on the light-source structure, and the location of the resilient element is not limited on condition that the location of the resilient element will not influence the illumination of the light-emitting component The process to build the resilient element is quite flexible.

Accordingly, the present invention provides a backlight module. Exploiting the bend portion structure of the resilient element to make the resilient element keep the interference function after assembling to achieve the grounding purpose. And, using a resilient element produced by the metal punched one-piece form is set on the back-plate or the cover of the light-source structure to electrically contact with the back-plate and the light-source structure in a forced-interference manner to provide a discharge path for the electric charge. Besides, the electrical-contact manner by using a resilient element is adopted to replace the fixing manner by using a screw and the adhering manner by using a conductive aluminum foil. It can reduce the complexity of the manufacturing process and raise the production yield and the productivity. Furthermore, the backlight module can provide a good grounding effect under the condition that no assembly complexity for the backlight module is increased.

Although the present invention has been explained in relation to its preferred embodiment, it is to be understood that other modifications and variation can be made without departing the spirit and scope of the invention as hereafter claimed.

What is claimed is:

1. A backlight module, comprising:
a back-plate;
a light-source structure set on said back-plate, wherein said light-source structure includes a cover and a light-emitting component set inside said cover; and
a resilient element set on said back-plate and tightly touched said cover, wherein said cover electrically contacts with said back-plate via said resilient element.

2. A backlight module according to claim 1, wherein said resilient element includes a bend portion.

3. A backlight module according to claim 2, wherein said cover of said light-source structure is fixed on said back-plate by using said bend portion of said resilient element.

4. A g backlight module according to claim 1, wherein said back-plate and said resilient element are one-piece form.

5. A backlight module according to claim 1, wherein said light-emitting component is selected from the group consisting of a cold cathode fluorescent lamp and a hot cathode fluorescent lamp.

6. A backlight module according to claim 5, wherein said cover is a reflective cover.

7. A backlight module according to claim 1, wherein said light-emitting component is composed of a plurality of light emitting diodes.

8. A backlight module, comprising:
a back-plate;
a light-source structure set on said back-plate, wherein said light-source structure includes a cover, and a light-emitting component set inside said cover; and
a resilient element set on said cover of said light-source structure and tightly touched said back-plate, wherein said cover electrically contacts with said back-plate via said resilient element.

9. A backlight module according to claim 8, wherein said resilient element includes a bend portion.

10. A backlight module according to claim 9, wherein said cover of said light-source structure is fixed on said back-plate by using said bend portion of said resilient element.

11. A backlight module according to claim 9, wherein said cover of said light-source structure electrically contacts with said back-plate via said bend portion of said resilient element.

12. A backlight module according to claim 8, wherein said cover of said light-source structure and said resilient element are one-piece form.

13. A backlight module according to claim 8, wherein said light-emitting component is selected from the group consisting of a cold cathode fluorescent lamp and a hot cathode fluorescent lamp.

14. A backlight module according to claim 13, wherein said cover is a reflective cover.

15. A backlight module according to claim 8, wherein said light-emitting component is composed of a plurality of light emitting diodes.
